(19) United States
(12) Patent Application Publication
(10) Pub. No.: US 2008/0203325 A1
(43) Pub. Date: Aug. 28, 2008

(54) Method of Protecting a Radiation Source Producing Euv-Radiation and/or Soft X-Rays Against Short Circuits

(75) Inventors: Dominik Marcel Vaudravange, Neuss (DE); Jeroen Jonkers, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,198

(22) PCT Filed: Jun. 6, 2006
(86) PCT No.: PCT/IB2006/051796

§ 371 Date: Dec. 12, 2007

(30) Foreign Application Priority Data
Jun. 14, 2005 (EP) 05105215.7

(51) Int. Cl. H05G 2/00

(52) U.S. Cl. 250/503.1

(57) ABSTRACT

The present invention relates to a method of protecting a radiation source producing extreme ultraviolet radiation (EUV) and/or soft X-rays against short circuits. The method applies to radiation sources producing said EUV-radiation and/or soft X-rays by means of an electrically operated discharge, which is ignited in a vapor between at least two electrodes (1, 2) in a discharge space, wherein said vapor is produced from a metal melt (6), which is applied to a surface in said discharge space and at least partially evaporated by an energy beam (9). Such a radiation source has one or several small gaps (17) between said electrodes (1, 2) and/or between components (4, 5) electrically connected to said electrodes (1, 2). These gaps (17) can cause short circuits when evaporated metal condenses there. In the present method during operation of the radiation source at least one surface bordering said gaps (17) and/or one or several protective elements (16, 18) covering said gaps (17) or arranged inside said gaps (17) are heated to a temperature at which the vapor pressure of said metal is high enough to evaporate metal material condensed on said surface or protective elements. With the present method the lifetime of the radiation source is extended.

The present invention relates to a method of protecting a radiation source producing extreme ultraviolet radiation (EUV) and/or soft X-rays against short circuits, said radiation source producing said extreme ultraviolet radiation and/or soft X-rays by means of an electrically operated discharge, which is ignited in a vapor between at least two electrodes in a discharge space, wherein said vapor is produced from a metal melt, which is applied to a surface in said discharge space and at least partially evaporated by an energy beam, in particular by a laser beam, said radiation source having one or several small gaps between said electrodes and/or between components electrically connected to said electrodes.

Radiation sources emitting EUV-radiation and/or soft X-rays are in particular required in the field of EUV lithography. The radiation is emitted by a hot plasma produced by a pulsed current. The most powerful EUV-radiation sources known up to now have been operated with metal vapor to generate the required plasma. An example of such an EUV-radiation source is shown in WO 2005/025280 A2, which is included herein by reference. In this known radiation source the metal vapor is produced from a metal melt which is applied to a surface in the discharge space and at least partially evaporated by an energy beam, in particular by a laser beam. In a preferred embodiment of this radiation source the two electrodes are rotatably mounted forming electrode wheels which are rotated during operation of the radiation source. The electrode wheels dip during rotation into containers with the metal melt. A pulsed laser beam is directed directly to the surface of one of the electrodes in the discharge space in order to generate the metal vapor from the adhered metal melt and ignite the electrical discharge. The metal vapor is heated by a current of some kA up to some 10 kA so that the desired ionization stages are excited and light of the desired wavelength is emitted. After this electrical discharge the metal vapor cools down and condenses on cold surfaces of components of the radiation source.

One of the main problems of such a radiation source is the protection of gaps between the electrodes and/or between components electrically connected to the electrodes. In the described radiation source such components are for example the two containers which are electrically connected to the electrodes through the metal melt. These containers are arranged at a small distance since the electrodes dipping into said containers must be close enough to enable the generation of the plasma discharge with low inductance. A condensation of metal vapor or a deposition of metal droplets in such gaps can cause short circuits, strongly limiting the lifetime of the radiation source. In this context it has to be taken into account that during an operation of the radiation source depending on the time of operation, some gg. up to a kg of metal are evaporated in the discharge space which later on condense on cold components of the radiation source.

In the above WO 2005/025280 A2 it is proposed to arrange protective elements in the radiation source which cover the gaps at least partly in order to avoid the diffusion of metal vapor into the gaps or the deposition of droplets in the gaps. These protective elements are kept at a temperature at which the metal vapor condenses on these elements and can flow back into the containers. Although with such a measure the lifetime of the radiation source can be extended by one or two orders of magnitude, this is not yet sufficient for a commercial application of the radiation source.

An object of the present invention is to provide a method of protecting a radiation source of the above mentioned type against short circuits, which results in a longer lifetime of the radiation source.

The object is achieved with the method according to claim 1. Advantageous embodiments of the method are subject matter of the dependent claims or are disclosed in the subsequent description and examples.

The present method relates to the protection of a radiation source producing EUV-radiation and/or soft X-rays by means of an electrically operated discharge, which is ignited in a vapor between at least two electrodes in a discharge space, wherein said vapor is produced from a metal melt, which is applied to a surface in said discharge space and at least partially evaporated by an energy beam, in particular a laser beam. Said radiation source has one or several small gaps between said electrodes and/or components electrically connected with said electrodes, which gaps can cause short circuits when metal vapor diffuses into the gaps and condenses there. The same applies to metal droplets which can deposit in these gaps. In the present method during operation of the radiation source at least one surface bordering said one or several gaps and/or one or several protective elements covering said one or several gaps or arranged inside said one or several gaps are heated to a temperature at which a vapor pressure of said metal is high enough to evaporate metal material condensed or deposited on said surface or protective element. Said surface can be the surface of the electrodes in the region of the small gap or the surface of the components forming the gap and electrically connected to the electrodes. The protective elements can be metal shields arranged to protect the gaps, in particular metal shields which are already used in the known radiation source of WO 2005/025280 A2. Due to the heating of these surfaces or elements to this high temperature the metal vapor does not condense on these surfaces or elements and deposited metal droplets are evaporated from these surfaces or elements, so that no material bridge causing a short circuit can grow on said surfaces or elements. In the following description the metal vapor and metal droplets are also called fuel.

Depending on the fuel used in the radiation source, for example Sn, In, Sb, Te or Li, the above surfaces or elements have to be heated to temperatures between 400° C. and 1500° C. Preferably, the surfaces or elements are heated to a temperature at which no net deposition of said fuel occurs. This means that with time the amount of fuel deposited or condensed on said surfaces or elements does not increase. Good results are achieved when the temperature is selected such that the vapor pressure of the fuel used in the radiation source is at least 10 Pa at this temperature. The heating can be achieved in the present method by special heating elements integrated in said protective elements and/or surfaces of the electrodes and/or components. Another possibility is to use the heating effect caused by absorption of the generated EUV-radiation and/or soft X-rays. In this context it should be realized that the components of the radiation source are normally cooled in order to maintain a temperature slightly above the melting temperature of the fuel of the source. This temperature is not high enough, to evaporate the fuel. In order to achieve the higher temperature in the special regions of the gaps it is possible to reduce the cooling of said regions so that the higher temperature is achieved with the heating effect of the EUV-radiation and/or soft X-rays. The surfaces or elements which are heated according to the present invention are preferably made of a material with a high melting point, e.g. of molybdenum or tungsten.

If the radiation source to be protected against such short circuits does not yet comprise protective elements, it is advantageous according to the present method to arrange such protective elements within said radiation source. This can be achieved for example by fixing a protruding rim to one of two components forming the gap, said rim covering the entrance of the gap at least partly. Another possibility is to arrange a metal plate between the two surfaces forming the gap, said metal plate separating the gap into two parts.

In the present description and claims the word “comprising” does not exclude other elements or steps and neither does “a” or “an” exclude a plurality. Also any reference signs in the claims shall not be construed as limiting the scope of these claims.

Examples of the present method are described in the following in connection with the accompanying drawings without limiting the scope of the claims. The figures show:

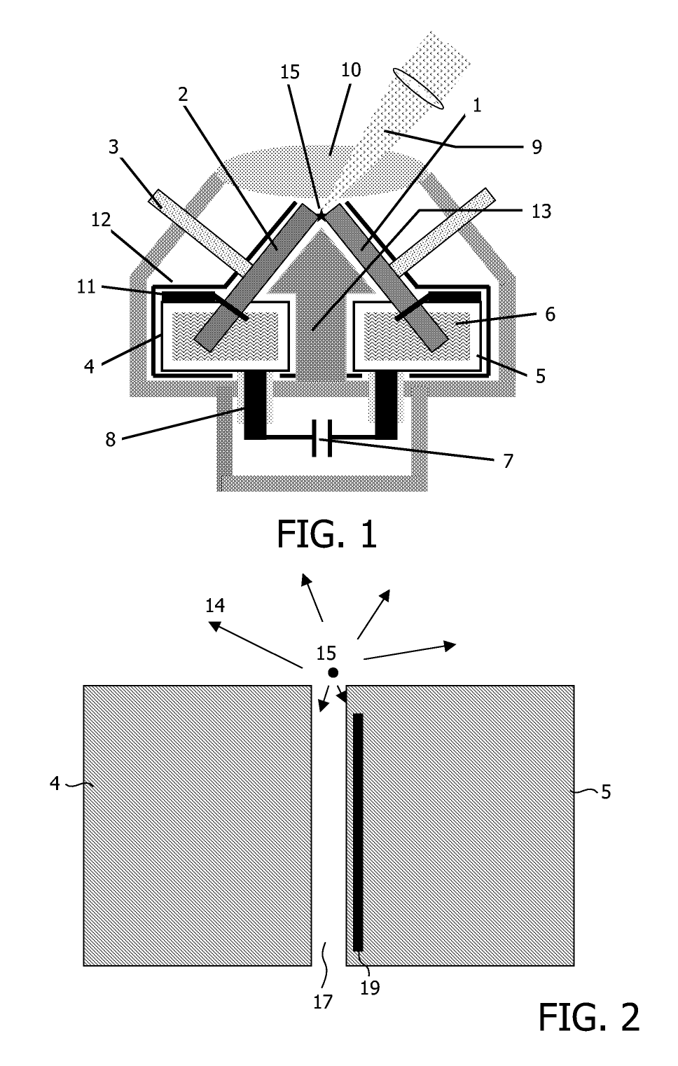

FIG. 1 a schematic view of a radiation source to which the method can be applied;

FIG. 2 a schematic view of two components of a radiation source forming a gap;

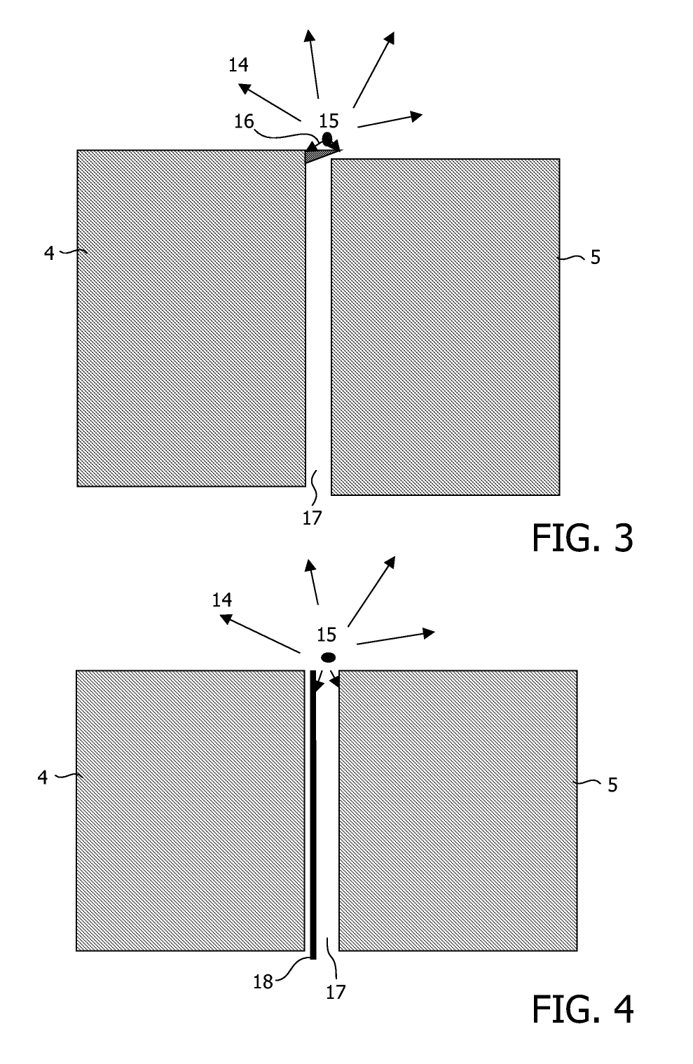

FIG. 3 a schematic view of two components of a radiation source forming a gap covered by a protective element; and

FIG. 4 a schematic view showing a further example of two components of a radiation source forming a gap, in which a protective element is arranged.

FIG. 1 shows a schematic side view of a radiation source to which the present method can be applied. This radiation source comprises two electrodes 1, 2 arranged in a discharge space of predefinable gas pressure. The disc-shaped electrodes 1, 2 are rotatably mounted, i.e. they are rotated during operation about an axis of rotation 3. During rotation the electrodes 1, 2 partially dip into corresponding containers 4, 5. Each of these containers 4, 5 contains a metal melt 6, in the present case liquid tin. The metal melt 6 is kept at a temperature of approximately 300° C., i.e. slightly above the melting point of 230° C. of tin. The metal melt in the containers 4, 5 is maintained at the above operation temperature by a heating device or a cooling device (not shown in the figure) connected to said containers. During rotation the surface of the electrodes 1, 2 is wetted by the liquid metal, so that a liquid metal film forms on said electrodes. The layer thickness of the liquid metal on the electrodes 1, 2 is controlled by means of skimmers 11. The current to the electrodes 1, 2 is supplied via the metal melt 6, which is connected to the capacitor bank 7 via an insulated feedthrough 8.

A laser pulse 9 is focused on one of the electrodes 1, 2 at the narrowest point between the two electrodes. As a result, a part of the metal film located on the electrodes 1, 2 evaporates and bridges over the electrode gap. This leads to the disruptive discharge at this point and a very high current from the capacitor bank 7. The current heats the metal vapor or fuel to such high temperatures that the latter is ionized and emits the desired EUV-radiation in a pinch plasma 15.

In order to prevent the fuel from escaping from the radiation source a debris mitigation unit 10 is arranged in front of the radiation source. This debris mitigation unit allows the straight pass of radiation out of the radiation source but retains a high amount of debris particles on their way out of the radiation source. In order to avoid the contamination of the housing of the radiation source a screen 12 may be arranged between the electrodes 1, 2 and the housing of the radiation source.

A problem of such a radiation source is that the two containers 4, 5 have to be arranged very close together, so that fuel condensing as vapor or depositing as droplets between these two containers may lead to a short circuit of the EUV-lamp. In order to avoid such a short circuit in the known lamp shown in FIG. 1 a metal shield 13 is arranged in the gap between the two containers, said metal shield 13 covering the gap in order to reduce the diffusion of fuel into said gap. In spite of such a protective element the diffusion cannot be suppressed totally. Therefore, fuel can condense or deposit in the gap between the two metallic containers 4, 5 or, in the case of the arrangement of FIG. 1, for example between each of the containers 4, 5 and the metal shield 13, thereby leading to a short circuit of the lamp.

This short circuit can be avoided by applying the method of the present invention to such a radiation source. FIG. 2 shows a very schematic view of two components of such a radiation source, in the present case the two containers 4, 5. Metal vapor or metal droplets 14 of a plasma discharge 15 of the radiation source can deposit on the surfaces of these containers 4, 5 bridging the gap 17 between the two components. One possibility to avoid the condensation on the surfaces is to heat one or both of these surfaces bordering the gap 17 to a temperature, at which the vapor pressure of the fuel used for plasma generation is high enough to evaporate the fuel. This heating can be achieved by special heating elements 19, schematically indicated in FIG. 2, or by less efficient cooling of these surfaces of the containers 4, 5. The surfaces are then heated by the generated EUV-radiation to a higher temperature than the remaining surfaces of the containers which have to be kept only slightly above the melting temperature of the fuel.

FIG. 3 shows a further example for applying the present method. In this case a metallic protruding rim 16 is fixed to one of the containers 4, 5 thereby covering the gap 17 between the containers. Due to this coverage less fuel can enter the gap 17 between the containers 4, 5. Furthermore, since the rim 16 is heated to a temperature high enough for the fuel not to condense on said rim, a short circuit between the rim 16 and the adjacent container 5 cannot occur.

FIG. 4 shows a further example of the present method, in which a metal plate 18 is arranged between the two containers 4, 5. This metal plate is heated to a temperature at which the fuel does not condense on this metal plate. Due to this heating the metal vapor or metal droplets 14 of the fuel entering the gap 17 cannot grow to form a short circuit bridge between the containers 4, 5 and the metal plate 18. Such a metal plate 18 can be formed for example by the metal shield 13 of FIG. 1. This metal shield 13 is then heated to the above temperature according to the present invention in order to avoid the condensation of fuel.

In the present examples the method has been explained with reference to the containers 4, 5 shown in FIG. 1. Nevertheless it is obvious that the present method can also be applied to other components electrically connected to the electrodes and forming such a small gap. Furthermore, when heating the protective element it is also possible to additionally heat the adjacent surfaces of the electrodes or components. The heating itself can in each case be achieved with common heating means, for example heating wires, heating elements, heating by the radiation of the radiation source itself or by the radiation of an additional radiation source. The heating is applied locally in the regions of the gaps which could cause short circuits.

### LIST OF REFERENCE SIGNS

1 electrode
2 electrode
3 axis of rotation
4 container
5 container
6 metal melt
7 capacitor bank
8 feedthrough
9 laser pulse
10 debris mitigation unit
11 skimmer
12 shield
13 metal shield
14 metal vapor/droplets
15 pinch plasma
16 protruding rim
17 gap
18 metal plate
19 heating elements

1. A method of protecting a radiation source producing extreme ultraviolet radiation (EUV) and/or soft X-rays against short circuits, said radiation source producing said extreme ultraviolet radiation (EUV) and/or soft X-rays by means of an electrically operated discharge, which is ignited in a vapor between at least two electrodes (1, 2) in a discharge space, wherein said vapor is produced from a metal melt (6), which is applied to a surface in said discharge space and at least partially evaporated by an energy beam, in particular by a laser beam, said radiation source having one or several small gaps (17) between said electrodes (1, 2) and/or between components (4, 5) electrically connected to said electrodes (1, 2), characterized in that during operation of the radiation source at least one surface limiting said one or several gaps (17) and/or one or several protective elements (16, 18) covering said one or several gaps (17) or being arranged inside said one or several gaps (17) is/are heated to a temperature at which the vapor pressure of said metal is high enough to evaporate metal material condensed on said surface or protective element (16, 18).

2. A method as claimed in claim 1, characterized in that said surface and/or one or several protective elements (14, 18) is/are heated to a temperature at which no net deposition of said metal occurs.

3. A method as claimed in claim 1, characterized in that said surface and/or one or several protective elements (16, 18) is/are heated to a temperature above 400° C.

4. A method as claimed in claim 1, characterized in that said one or several protective elements (16, 18) are protruding rims (16) fixed to said electrodes (1, 2) and/or components (4, 5) and covering said one or several gaps (17).

5. A method as claimed in claim 1, characterized in that said one or several protective elements (16, 18) are metal plates (18) arranged inside the gaps (17) to separate the gaps (17) into two parts.

6. A method as claimed in claim 1, characterized in that said surface and/or one or several protective elements (14, 18) is/are heated by integrated electrical heating elements (19).

7. A method as claimed in claim 1, characterized in that said surface and/or one or several protective elements (14, 18) is/are heated by said extreme ultraviolet radiation (EUV) and/or soft X-rays of said radiation source.

8. A method as claimed in claim 1 for preventing short circuits in a radiation source in which said electrodes (1, 2) can be placed in rotation during operation and dip, while rotating, into containers containing the metal melt (6), said containers representing said components (4, 5) electrically connected to said electrodes (1, 2).
